(19) United States
(12) Patent Application Publication
(10) Pub. No.: US 2009/0292785 A1
(43) Pub. Date: Nov. 26, 2009

(54) SYSTEM AND METHOD FOR DYNAMIC CONTACT LISTS

(75) Inventors: Gregory Leedberg, Milton, MA (US); Kenneth D. Carey, Boston, MA (US); George W. Spencer, JR., Westborough, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(73) Assignee: Raytheon Company, Waltham, MA (US)

(21) Appl. No.: 12/468,116

(22) Filed: May 19, 2009

Related U.S. Application Data
(60) Provisional application No. 61/128,345, filed on May 20, 2008.

(51) Int. Cl. G06F 15/82

(52) U.S. Cl. 709/206

(57) ABSTRACT

A collaborative messaging system includes a communications engine for sending and receiving messages among a plurality of users, including a contact generator to generate at least one user contact, a plurality of user filters, each associated with at least one of the plurality of users, and a plurality of user contact lists, each associated with at least one of the plurality of users and adapted to contain at least one user contact. In response to a comparison between user filters, the contact generator is configured to update at least one of the plurality of user contact lists.

### RELATED APPLICATIONS

This application claims the benefit of U.S. Provisional Application No. 61/128,345 filed May 20, 2008 under 35 U.S.C. §119(e) which application is hereby incorporated herein by reference in its entirety.

### FIELD OF THE INVENTION

The subject matter described herein generally relates to contact lists for collaborative messaging and in particular, to dynamically generating contact lists for collaborative messaging.

### BACKGROUND

As is known in the art, so-called “chat” or “instant messaging” services enable users to view presence information of other users and communicate with others on predefined contact lists called “buddy lists.” This requires users to know about and be aware of contacts and to add contacts to buddy lists before any communication can begin.

### SUMMARY

In accordance with the systems, techniques, and concepts described herein, a collaborative messaging system includes a communications engine for sending and receiving messages among a plurality of users. The communications engine includes a contact generator to generate at least one user contact, a plurality of user filters, each associated with at least one of the plurality of users, and a plurality of user contact lists, each associated with at least one of the plurality of users and adapted to contain at least one user contact. The contact generator is configured to update at least one of the plurality of user contact lists in response to a comparison between user filters.

In further embodiments, the collaborative message system includes one or more of the following features: the communications engine sends and receives messages over a chat session between ones of the plurality of users based upon the user contact lists associated with the users; each of the plurality of user filters comprises at least one personal user attribute; each of the plurality of user filters comprises at least one communications attribute related to at least one of the messages; each of the plurality of user filters comprises at least one contextual attribute related to a context of the associated at least one user; each of the plurality of user filters includes a plurality of user attributes and the communications engine generates a first portion of the plurality of the user attributes; the communications engine generates a second portion of the plurality of user attributes in response to a request to enter the second portion of the plurality of user attributes; a filter processor for comparing user filters in response to a request from at least one of the plurality of users, wherein the request is related to a user filter associated with the requesting user; the communications engine is further configured to send a message to one of the plurality of users associated with an updated user contact list; in response to the comparison between user filters, the contact generator is configured to update at least one of the plurality of user contact lists by adding or removing a user contact from one of the user contact lists; in response to the comparison between user filters, the contact generator is configured to update at least one of the plurality of user contact lists by changing information associated with a user contact contained on a user contact list, and; the communications engine is further configured to send an offer to add the at least one generated contact and the contact generator is further configured to add the at least one generated user contact to at least one of the plurality of user contact lists in response to a request to add the at least one generated user contact.

In another aspect, a collaborative messaging method includes in a communications engine, providing a plurality of user filters, each associated with at least one of a plurality of users, and a plurality of user contact lists, each associated with at least one of the plurality of users and adapted to contain at least one user contact. The method further includes performing a comparison between user filters and generating the at least one user contact and updating at least one of the user contact lists.

In further embodiments, the method includes one or more of the following features: sending and receiving messages over a chat session among ones of the plurality of users based upon the user contact lists associated with the users; each of the plurality of user filters comprises at least one personal user attribute; each of the plurality of user filters comprises at least one communications attribute related to at least one communications message; each of the plurality of user filters comprises at least one contextual attribute related to a context of the associated ones of the users; each of the plurality of user filters comprises a plurality of user attributes and further including generating a first portion of the plurality of the user attributes; generating a second portion of the plurality of user attributes in response to a request to enter the second portion of the plurality of user attributes; performing a comparison between user filters includes comparing user filters in response to a request from at least one of the plurality of users, wherein the request is related to a user filter associated with the at least one requesting user; sending a message to one of the plurality of users associated with an updated user contact list; performing a comparison between user filters includes updating at least one of the plurality of user contact lists by adding or removing a user contact from one of the user contact lists; performing a comparison between user filters includes updating at least one of the plurality of user contact lists by changing information associated with a user contact contained on a user contact list, and; sending an offer to add the at least one generated contact and adding the at least one generated user contact to at least one of the plurality of user contact lists in response to a request to add the at least one generated user contact.

Conventional messaging services, such as chat services, enable chat users to view presence information about other chat users on their predefined buddy lists. For example, a user can view whether a contact is online and, if so, begin chatting with the contact. Although buddy lists are suited to provide privacy to chat users, they do not facilitate ad-hoc communication and information sharing with unknown contacts or in response to unpredictable situations.

As is often the case in dynamic environments (e.g., military operations, emergency situations, terror alerts, etc.), people need to collaborate and share information with each other to successfully manage an event. However, people may not know about or be aware of each other and/or may not have the time or ability to discover each other in order to add important contacts to their buddy lists, especially while the event unfolds and people must attend to the tasks at hand. Therefore, conventional chat services are unable to accommodate more dynamic environments in which events can unfold in unpredictable ways and many different users who don't know about each other are involved. This may result in inefficiencies, misinformation, poor planning, and/or inadequate problem resolution. Worse yet, lives and property may be at stake, as people fail to mitigate the consequences of an event.

The inventive concepts described herein enable dynamic discovery of people relevant to a task at hand. Based upon on user attributes such as roles and responsibilities, and/or contextual attributes such as event status and conditions, and/or communications attributes such as problems and concerns revealed in messages, the inventive systems and techniques described herein dynamically generate contacts to enable collaboration and information-sharing among various stake holders in a dynamic environment, such as joint responders, medical staff, law enforcement officials, military command-and-control personnel, dispatchers, etc. Such presence information and awareness of other users can serve to mitigate the consequences of an event and result in improved event outcome.

### BRIEF DESCRIPTION OF THE DRAWINGS

The foregoing features of this invention, as well as the invention itself, may be more fully understood from the following description of the drawings in which:

FIG. 1 is a block diagram of components of a collaborative messaging system according to the invention;

FIG. 2 is a block diagram of an exemplary environment incorporating the collaborative messaging system of FIG. 1.

FIG. 3 is a block diagram of an embodiment of an illustrative user filter, user filter attributes, and user contact lists associated with a user.

FIG. 4 is a pictorial representation of an illustrative embodiment of an update-filter screen display produced in the course of operating an illustrative embodiment of the inventive concepts;

FIG. 5A is a block diagram of an exemplary chat session using the collaborative messaging system of FIG. 1;

FIG. 5B is a block diagram of another exemplary chat session using the collaborative messaging system of FIG. 1;

FIG. 6 is a flow diagram of an embodiment of a method of collaborative messaging involving dynamically generated user contact lists according to an aspect of the invention;

FIG. 7 is a flow diagram of a more detailed embodiment of the method of collaborative messaging of FIG. 6; and

FIG. 8 is a diagram showing an exemplary hardware and operating environment of a suitable computer for use with embodiments of the invention.

### DETAILED DESCRIPTION

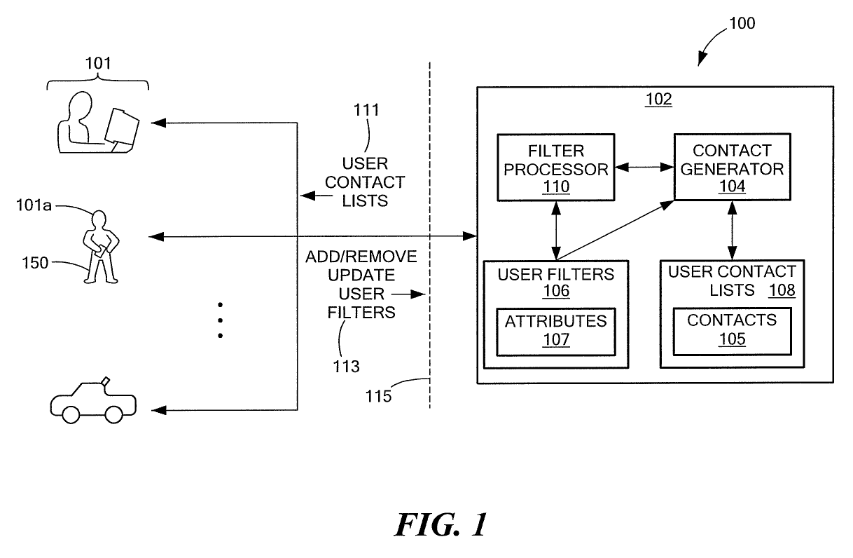

Referring to FIG. 1, a collaborative messaging system 100 includes a communications engine 102 for sending and receiving messages among a plurality of users 101. The communications engine 102 includes a contact generator 104 to generate at least one user contact 105 and a plurality of user filters 106, each associated with at least one of the plurality of users 101. The communications engine 102 further includes a plurality of user contact lists 108, each associated with at least one of the plurality of users 101 and adapted to contain at least one user contact 105. In response to a comparison between user filters 106, the contact generator 104 is configured to update at least one of the plurality of user contact lists 108.

In one embodiment, a filter processor 110 updates at least one of the user filters 106, for example, by adding user filters 106 and/or removing user filters 106 and/or changing information in user filters 106. The contact generator 104 further compares user filters 106 to generate at least one user contact. For example, the contact generator 104 generates a user contact based upon user filter similarities and/or differences. Still further, the contact generator 104 generates contacts 105 based upon changed information in user filters 106.

As will be described in detail below, the communications engine 102 sends and receives messages among a plurality of users 101. In one embodiment, the communications engine 102 sends and receives text messages among a first user and a second user who work together to mitigate the consequences of an event, such as a multi-vehicle accident. For example, the first user, who is a public safety answering point dispatcher, may desire to send a text message to the second user, who is a responder at the scene of the accident. For example, the first user may ask the second user whether hazardous materials are involved in the crash. The first user composes the text message, for example, on a text message composer executing on a desktop computer and sends the message. The message may include other information such as the second user's contact information and the first user's contact information. In this embodiment, the communications engine 102 receives the message, determines that the second user should receive the message (along with any other users who should receive the message) and sends the message to the second user. The second user views the text message, for example, on a portable hand-held device.

The contact generator 104 dynamically generates user contacts 105 which include information for identifying one or more users 101 of the collaborative message system. In one embodiment, user contacts 105 include a user name and a unique user identifier used by a messaging system to, for example, forward messages intended for a user, such as the first user and/or the second user described above. In a further embodiment, the user contacts 105 include electronic addresses for sending and receiving messages among the users 101. In still a further embodiment, user contacts 105 include electronic mail (e-mail) addresses used by an e-mail server, text-messaging addresses used by a text-messaging server, or any other appropriate electronic contact information to identify message recipients.

In still other embodiments, user contacts 105 include information associated with a radio frequency identification (RFID) tag used in wireless communications systems. The RFID tag may be associated with a user device, such as an RFID card used to gain access to a secure facility, or a mobile communications device such as a wireless communications device used at the scene of an incident, such as the multi-vehicle accident described above.

The user filters 106 include attributes 107 to describe users 101. In one embodiment, each user filter is associated with one user. However, in other embodiments, a user filter may describe more than one user, such as those within a group of users who have the same or similar attributes (e.g., a team of medical technicians). User filters 106 include attributes used to generate important, needed, and/or desired contacts 105 for one or more users.

In one embodiment, user filters 106 describe personal attributes of a user, contextual attributes related to the user's task-at-hand, and/or communication attributes related to what the user is communicating about, and/or the information the user needs or desires. In another or the same embodiment, a user filter includes user attributes such as personal information related to the user, and/or contextual attributes such event or incident-driven attributes, and/or communications attributes such topics of communications and/or relevant information. As will be described in further detail, user filter attributes 107 may be user-provided and/or automatically generated by the communications engine 102, for example, by searching messages and downloaded information. In an exemplary application, a user provides personal information by entering the information into a web browser and submitting the information to the communications engine 102.

In still other applications, the communications engine 102 generates contextual attributes automatically, for example, by processing information from external sources, such as aircraft position information from a radar tracking system. In further embodiments, the communications engine 102 generates communications attributes by parsing user messages to identify keywords, such as suspect descriptions from one or more user-reported sightings. In still other embodiments, users may provide the contextual and/or communications attributes. For example, users may provide a patient's vital statistics and/or a topic of interest, such as a particular patient treatment to learn about any side-effects.

The user contact lists 108 include one or more user contact 105, such as the e-mail address or text-messaging address of a user in the embodiment described above. In one embodiment, each user contact list is associated with one user (i.e., a user contact list includes the one or more user contacts 105 established for one user). However, in other embodiments, a user contact list may be associated with more than one user, such as those within a group of users who have the same or similar attributes (e.g., a team of medical technicians). In still other embodiments, a user contact list may be empty (i.e. have no contacts).

In one exemplary embodiment of the collaborative message system 100, a user contact list may be shared among users who perform the same job or task, but on different time shifts. For example, a day time security guard may share a user contact list with a night time security guard. In still another embodiment, a user may be associated with more than one user contact list. For example, a user may be associated with a first contact list for a first job, and a second contact list for a second job.

Referring again to FIG. 1, the contact generator 104 dynamically generates and/or updates user contacts 105 in response to a comparison between user filters 106. In one embodiment, the contact generator 104 compares a first user filter and a second filter and generates a first user contact. For example, the first user filter may describe a nurse practitioner at a hospital who is caring for an Alzheimer's patent. The first user filter may include attributes 107, such as personal information as may include the nurse practitioner's name, years of experience, location of employment, etc., contextual attributes as may include the patient's condition, length of stay at the hospital, any prior complications, history/progress of the patient's disease, etc., and communications attributes as may include content from the nurse's messages inquiring about a particular Alzheimer's treatment, AZT. The second user filter may describe a medical researcher who helped develop and test AZT and is identified as an AZT expert.

In this embodiment, the contact generator 104 compares the first and second filter, for example, by performing a text-based search of the respective filters and identifying any common text-based attributes or terminology. In an exemplary text-based search, the contact generator 104 determines that the nurse practitioner has been inquiring about AZT by reviewing the nurse practitioner's messages handled by the communications engine 102 and that the medical researcher is an expert in AZT by reviewing the medical researcher's personal attributes. Based on such a text-based match between the first and second user filters, the contact generator 104 generates the first user contact which includes the medical researcher's name, unique identifier, and contact information. For the result of the text-based comparison to cause action (e.g. adding a new contact) it is possible that one or more fields of one or more attribute types must match. It will be understood, however, that in some instances, an exact match may not be required, but some range of similarity or proximity between compared text or values.

It will be understood by one of ordinary skill in the art that a comparison between user filters 108 is not limited to the text-based comparison described above. As non-limiting examples, a comparison between user filters 108 to generate contacts 105 can include a geographic-based comparison that matches users within certain distances of each other, a semantic-based comparison that matches semantic relationships and concepts, and/or a query-based comparison that queries a database of user filter attributes 107.

The contact generator 104 performs various functions in response to a comparison between user filters 106. In one embodiment, the contact generator 104 generates and adds a generated user contact to a user contact list. For example, referring to the Alzheimer's patient example above, the contact generator 104 may add the first user contact for the medical researcher to the nurse practitioner's user contact list.

In another embodiment, the contact generator 104 removes a user contact from a user contact list. Again referring to the Alzheimer's patient example above, the contact generator 104 may remove the first user contact for the medical researcher from the nurse practitioner's user contact list when a doctor replaces the patient's AZT treatment with a different treatment.

In a further embodiment, the contact generator 104 changes information associated with a user contact contained in a user contact list. Yet again referring to the Alzheimer's patient example above, the contact generator 104 may change information associated with the first user contact. For example, the contact generator 104 may change the location of the medical researcher.

As described above, the communications engine 102 dynamically generates user contacts 105 and, in response to a comparison between user filters 106, updates user contact lists 108. In a further embodiment, the communications engine 102 is configured to offer the dynamically generated user contacts lists 108 to users 101 (generally designated by reference numeral 111 in FIG. 1). The users 101 may accept or reject the user contacts 105. For example, in one embodiment, the communications engine 102 sends to a client device 150 an extensible markup language (XML) file which includes a list of the generated user contacts 105. The client device 150 parses the XML file and presents the generated contacts 105 to a client device user 101a. In still a further embodiment, the communications engine 102 sends user contact lists 108 over a wireless network 115 to a mobile client device 150, such as a personal data assistant. The mobile client device 150 renders the user contact lists, for example, in a dynamic user contact browser. A user 101a may select one or more of the user contacts to add to a communications list used to send and receive messages during, for example, a chat session.

Advantageously, a user is able to discover user contacts and decide to communicate with the discovered user contacts based upon current contexts, tasks, problems, interests, events, etc. In one example application of the collaborative messaging system 100 used to manage and mitigate the consequences of a hurricane, a flood worker 101a is having difficultly enabling a remote power generator to provide temporary power for a group of flood victims of the hurricane's storm surge. During the flood worker's communications with other users 101, the contact generator 104 compares the flood worker's user filter, which may include personal attributes, and/or contextual attributes, and/or communications attributes with other user filters 106. Based upon content of the flood worker's 101a messages (i.e., one or more recent messages related to the power generator problem), the contact generator 104 generates a new user contact for the flood worker 101a including contact information for a technician with extensive power generator expertise (e.g., knowledge on how to operate and maintain the power generator). The contact generator 104 adds the technician to the flood worker's 101a user contact list. Upon receiving and viewing the updated user contact lists 108 (and updated contacts 105), the flood worker 101a accepts the new technician user contact, and contacts the technician to try to resolve the power generator problem.

In a further embodiment, the collaborative messaging system 100 includes a filter processor 110 for comparing user filters 106 in response to a request from at least one of the plurality of users 101, wherein the request is related to a user filter associated with the requesting user. The filter processor 110 performs comparisons that differ from those the contact generator 104 performs. In particular, whereas the contact generator 104 performs comparisons between one user filter and another user filter (i.e. to generate and/or update user contacts 105), the filter processor 110 performs comparisons between a user filter 106 and updated information for a user associated with the user filter. For example, the filter processor 110 may compare user filters 106 in response to a request to add, remove, and/or change user attributes 107 in the user filter (generally designated by reference numeral 113 in FIG. 1). In particular, the filter processor 110 processes user filter updates (i.e., adding or removing user filters and/or changing user filter attributes) and passes control to the contact generator 104 to generate and/or update user contacts 105 based upon any user filter updates. In this and other embodiments, the filter processor 110 and contact generator 104 perform comparisons between user filters 106 differ from the contact

In one embodiment, the filter processor 110 accepts a request to add a user filter associated with a user by searching through the existing user filters 106 to determine if a user filter already exists for the associated user. If no user filter exists, then the filter processor 110 adds the user filter. Otherwise, the filter processor 110 may update the existing user filter with any incoming filter attributes or generate an error message indicating that a user filter already exists for the associated user. Alternatively, the filter processor 110 can request confirmation from a user to update the user filter with any incoming filter information.

In another embodiment, the filter processor 110 accepts a request to remove a user filter by searching through the existing user filters 106 and determining if a user filter exists for the associated user. If no filter exists, then the filter processor 110 generates an error message. Otherwise, the filter processor 110 removes the user filter.

In a further embodiment, the filter processor 110 accepts a request to change user attributes 107 in a user filter by searching through existing user filters 106 to determine whether the user filter exists for the associated user. If no user filter exists, then the filter processor 110 generates an error message. Otherwise, the filter processor 110 updates the user filter associated with the user with the incoming filter attributes.

In another embodiment, the filter processor 110 compares user filters 106 automatically, for example, in response to updated information received from an external server. For example, the filter processor 110 may compare user filters 106 in response to updated traffic information. In the same or different embodiment, the filter processor 110 automatically compares user filters 106 at regular time intervals.

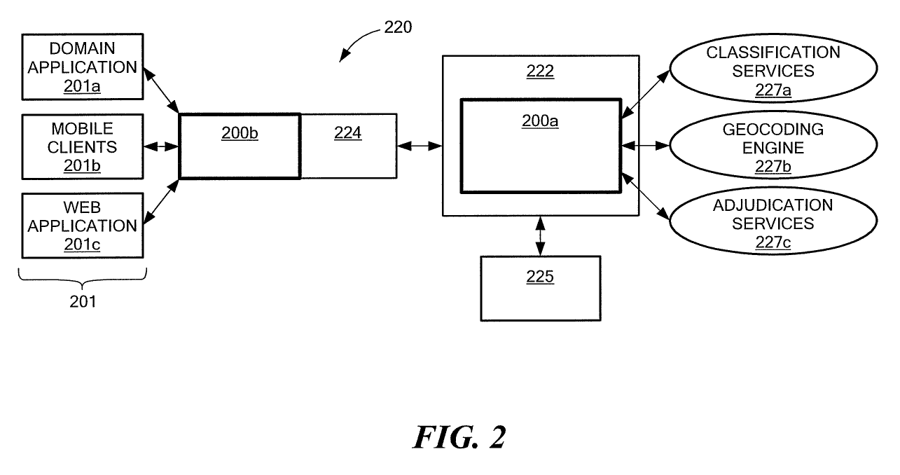

Referring now to FIG. 2, an exemplary environment 220 incorporating the inventive concepts includes a collaborative messaging server 200a, which in one embodiment is a server extension to an Extensible Messaging and Presence Protocol (XMPP) server 222. As is well known in the art, XMPP is an open, extensible markup language (XML) based protocol used in conjunction with instant messaging (IM), including presence information for IM, such as buddy lists. It should be noted that the collaborative messaging server 200a may be a server extension to other protocol servers, such as a Voice-Over Internet Protocol (VOIP) server, as well as services such as AOL Instant Messenger™, and MSN Messenger. The collaborative messaging server 200a may be used to dynamically generate user contacts for a radio gateway system. In such a system, users communicate with each other using radio devices, such as walkie-talkies, in contact with one or more radio base stations.

The XMPP server 222 may be extended, for example, by using an XMPP application programming interface (API) 224, which includes capabilities to add functionality to core XMPP services. The XMPP server 222 further communicates with external clients 225 including commercial off-the-shelf components such as Pidgin, a multi-platform IM client. Further, the XMPP Server 222 may access a lightweight directory access protocol (LDAP) (not shown) for querying and modifying directory services.

The collaborative message server 200a includes a collaborative messaging system, as may be like the collaborative messaging system 100 described in conjunction with FIG. 1. The collaborative messaging system includes functionality for dynamically generating user contacts based upon user filters, such as may be similar to user contacts 105 and user filters 106 described above in conjunction with FIG. 1. Clients 201, such as domain applications 201a, mobile clients 201b, and web applications 201c, use a collaborative messaging API 200b to extend collaborative messaging system functionality. Clients 201, such as client 201b, may be similar to clients, such as client 150, described in conjunction with FIG. 1.

The collaborative messaging server 200a uses external services to render a broad array of functionality. For example, the collaborative messaging server 200a uses classifications services 227a to obtain classification level information pertaining to message content, as well as message senders and message receivers. Such information may be used to block messages to those users without the proper clearance to view the messages, for example, by removing a user contact from a user contact list. The collaborative messaging server 200a uses a geocoding engine 227b to obtain geospatial information, such as a user's location. Such information may be used to add user contacts based upon distance. The collaborative messaging server 200a uses adjudication services 227c to process message content as well as user filter attributes based upon more or less restrictive values. For example, the adjudication services 227c may update user attributes entered by a user with more restrictive values, and the collaborative messaging server may remove a user contact from a user contact list accordingly.

It will be understood by one of ordinary skill in the art that the collaborative messaging server 200a and collaborative messaging API 200b can function across multiple servers, such as a plurality of XMPP servers 222.

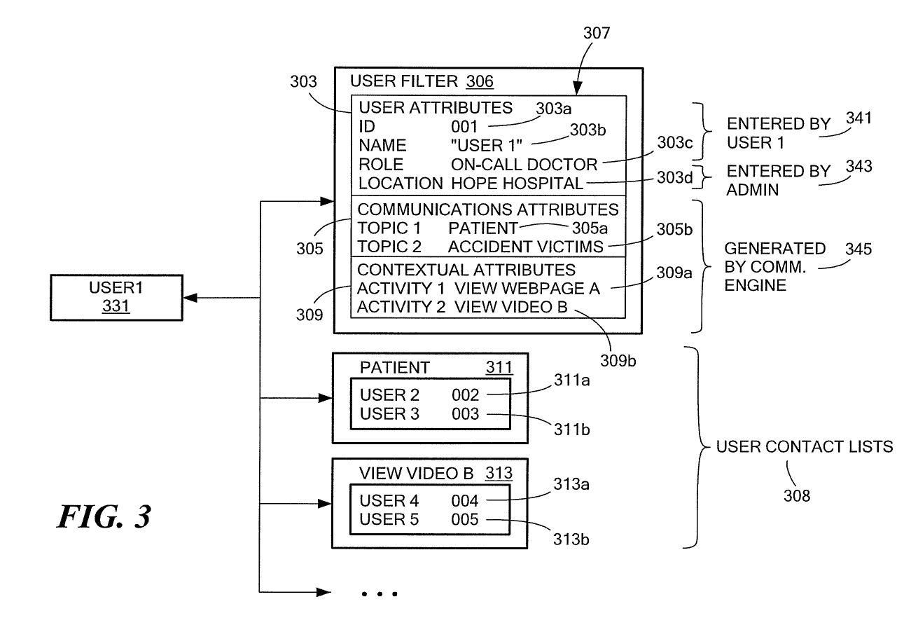

Referring now to FIG. 3, in one embodiment, a user 331 (hereinafter referred to as “USER 1”) is associated with a user filter 306 and user contact lists 308. The user filter 306 includes user attributes 307, such as user attributes 303 including an identification number or code 303a, a user name 303b, a user role 303c, and a user location 303d. The identification number 303a may be a unique number generated by a random number generator (seeded by current time-date) or by a primary key field of a database table such as 001. The user name 303b may be an alpha-numeric character string such as “USER 1.” The user role 303c may be the user's job title such as “ON-CALL DOCTOR.” The user location 303d may be the user's place of employment such as “HOPE HOSPITAL.” In other embodiments, the user location 303d is a place of interest, such as a landmark or an address. The landmark and/or address may be geo-coded using geographic coordinates.

In one embodiment, the user filter 306 also includes communications attributes 305. The communications attributes 305 may be related to one or more messages of a communications engine, as may be similar to the communications engine 102 described in conjunction with FIG. 1. For example, the communications attributes 305 may include one or more topics of communications which are discovered in the one or more messages. For example, an on-call doctor may be engaged in two primary topics of communications (denoted “TOPIC 1” and “TOPIC 2”), one related to a patient 305a and another related to an accident 305b.

In the same or different embodiment, the user filter 306 includes contextual attributes 309 for example as may be related to an incident, such as a natural disaster, terrorist attack, release of a bio-agent, etc. For example, the contextual attributes 309 may include user location information, such as geographical coordinates, street intersections, postal addresses, etc. In another example, the contextual attributes 309 include one or more user activities (denoted “ACTIVITY 1” and “ACTIVITY 2”), such as “VIEW WEBPAGE A” 309a and/or “VIEW VIDEO B” 309b.

Referring again to FIG. 3, in one embodiment, all or a portion of the user filter attributes 307 are generated by a user 341 (who may be USER 1), an administrator 343, or a communications engine 345, as may be similar to the communications engine 102 described with reference to FIG. 1. For example, a user on a mobile device may enter user filter attributes 307 using a graphical user interface and submit the user filter attributes 307 over a network to a collaborative message system, which performs dynamic discovery of user contacts based at least in part upon the submitted user filter attributes 307. In another example, an administrative user enters user filter attributes 307. For example, the administrative user may enter user privileges or may have access to secure information which only the administrative user can define. In still another example, a communications engine defines user filter attributes 307, such as the communications attributes 305 and contextual attributes 309.

Referring yet again to FIG. 3, in another embodiment, the USER 1 is associated with one or more user contact lists 308. For example, a first user contact list 311 relates to USER 1's patient and may include USER 2 311a and USER 3 311b. USER 2 311a and USER 3 311b may be members of a medical team caring for the patient. A contact generator, as may be similar to the contact generator 104 described in conjunction with FIG. 1, generates the first and second user contacts 311a, 311b based upon, for example, the USER 1's role and mutual assignment of USER 1, USER 2, and USER 3 to the patient. A second user contact list 313 relates to USER 1's viewing of video B. The contact generator may determine that USER 4 and USER 5 are concurrently (or have in the past) viewed video B and generates a USER 4 contact 313a and USER 5 contact 313b based on shared interest in video B.

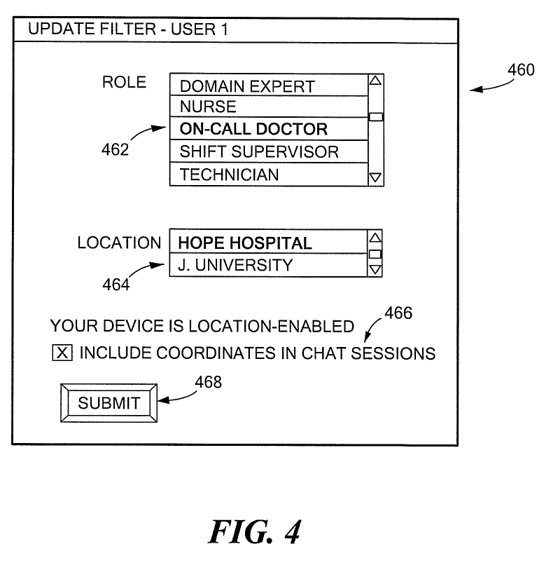

Referring now to FIG. 4, in one embodiment, a user enters user filter attributes using an UPDATE FILTER display screen 460. The display screen 460 may be displayed in a web browser, such as the Safari web browser manufactured by Apple Computer, Inc. of Cupertino, Calif. The user selects a role from a list of predefined user roles 462, and a location from a list of predefined locations 464. One or both of the lists 462, 464 may be populated from a database of defined user roles and user locations. The user may also indicate whether to include location information 466, for example, in any chat sessions within which the user participates. Such a feature may be enabled on a location-enable device, such as a device with a geographic processing system chip. The user submits the entered information using a submit button 468, which, in one embodiment, generates a hypertext transfer protocol (HTTP) request to a server, as will be explained in further detail below.

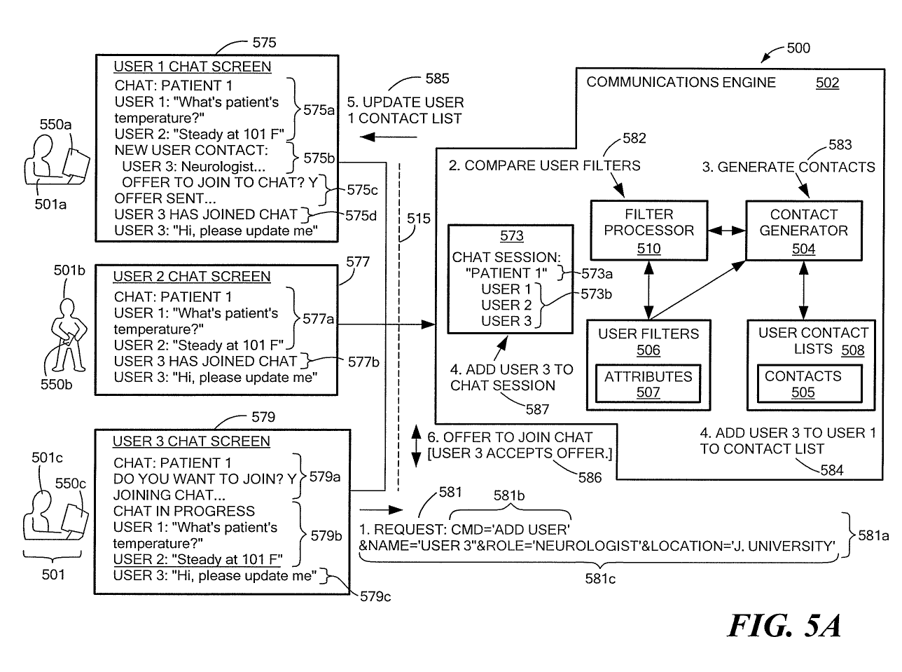

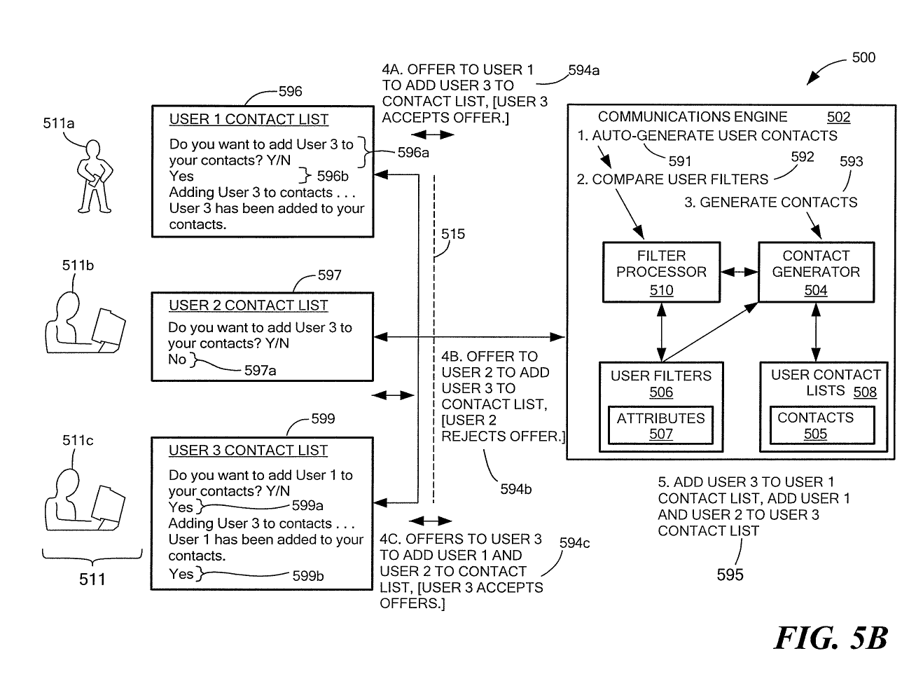

Referring now to FIG. 5A, an illustrative collaborative message environment 500 for sending and receiving messages among users includes a communications engine 502, as may be similar to the communications engine 102 of FIG. 1, for supporting a chat session 573 and for dynamically generating user contacts 505. The user contacts 505 are associated with users 501 who may be added to the chat session 573. An exemplary mechanism, whose operation is supported by the collaborative messaging system 500, adds user contacts 505 to user contact lists 508 and is designated by steps 581-587, as will be explained below. The collaborative message environment 500 includes a chat server (not shown), such as the XMPP server described in conjunction with FIG. 2. It will be understood that the collaborative messaging environment 500 may be used by other applications to dynamically generate and update user contacts including, but not limited to, radio gateway applications.

The exemplary chat session 573 includes a chat topic 573a (denoted “PATIENT 1”) and a list of participating users 573b. The chat session 573, includes a first user 501a, hereinafter referred to as “USER 1”, who is an on-call attendant at a hospital, and a second user 501b, hereinafter referred to as “USER 2”, who is a nurse at the hospital. USER 1 and USER 2 are chatting about a patient (subject of the chat topic “PATIENT 1”) who is suffering from head-trauma. USER 1 is in the patient monitoring office reviewing patient rosters, and USER 2 is bed-side with the patient, whose room is on a different floor than the patient monitoring office.

USER 1 uses a first chat client 575 executing on a first device 550a, such as a laptop computer and USER 2 uses a second chat client 577 executing on a second device 550b, such as personal data assistant. The first and second chat clients 575, 577 communicate with the collaborative messaging environment 500 over a network 515, such as an intranet or the Internet. The first and second users 501a, 501b compose, send, and receive chat text messages over the network 515 on their respective devices 575, 577. As can be seen in respective chat clients 575, 577, USER 1 and USER 2 are conversing about the patient's present temperature (generally designated by respective chat messages 575a and 577a).

A third user 501c, hereinafter referred to as “USER 3”, is a neurologist at J. University and an expert on head-trauma. USER 3, who is not currently engaged in the chat session 573, uses a third device 550a such as a desk top computer to enter his user filter attributes. In this example, USER 3 uses an UPDATE FILTER display screen (not shown), as may be similar to the display screen 460 described in conjunction with FIG. 4. As designated by step 581, USER 3 submits a request 581a to the communications engine 502 to add his user filter attributes to the collaborative messaging environment 500. In this example, the request 581a is a hypertext transfer protocol (HTTP) request to a web server (not shown) which is processed and passed to the communications engine 502.

The request 581a includes a request command 581b, “ADD USER,” which refers to an operation to be performed by the communications engine 502, and attributes 581c for user name, “USER 3”, user role, “NEUROLOGIST”, and user location, “J. UNIVERISTY.” It will be understood by one of ordinary skill in the art that other methods may be used besides HTTP to submit user filter attributes 507 to the collaborative messaging environment 500. For example, a user may use a touch-tone phone pad to enter and submit the information.

In response to the request 581a, the communications engine 502 compares the submitted user filter attributes 581c to one or more existing user filters 507, as designated by step 582, and generates user contacts 505, as designated by step 583. For example, a filter processor 510 processes the request 581a and determines that a user filter for USER 3 needs to be added to the collaborative messaging environment 500. The filter processor 510 adds the user filter for USER 3 and passes control to a contact generator 504. The contact generator 504 processes the added user filter, along with other attributes, such as contextual attributes and communications attributes, and generates one or more user contacts 505 in response to a comparison of user filters 506. In this example, the contact generator 504 generates a new user contact including USER 3's contact information to add to USER 1's user contact list based on the result of comparing USER 3's filter to USER 1's filter. In one exemplary embodiment, the contact generator 504 generates the new user contact based upon a match and/or similarity between USER 3's role as a neurologist as indicated in the USER 3's user filter and PATIENT 1's neurological problems associated with head trauma as indicated in the contextual attributes of USER 1's user filter and/or keywords found in USER 1's messages as indicated in the communications attributes of USER 1's user filter.

The communications engine 502 adds user contact USER 3 to USER 1's user contact list, as designated by step 584. In this example, the updated user contact list is sent to the first device for USER 1's review, as designated by step 585. The first chat client 575 notifies USER 1 about new user contact for USER 3 and provides a short description of USER 3 (which may include a set of informational messages generally designed by reference numeral 575b). As designated by step 586, in one embodiment, the communications engine 502 determines that an offer should be extended to USER 3 to join the chat, based upon processing of USER 3's filter attributes, since USER 3 can offer assistance and advice for treating the patient's injury. The communications engine 502 forwards a request to the first chat client 575 to prompt USER 1 (generally designated by reference numeral 575c) about whether or not to extend the offer to USER 3 to join the chat. In a further embodiment, the communications engine 502 automatically extends the offer to USER 3.

In this example, USER 1 indicates that an offer should be sent to USER 3 to join the chat, and the first chat client 575 sends the offer to USER 3 over the network 515. A third chat client 579 opens on USER 3's device and renders information about the chat session currently in progress as well as USER 1's offer to join the chat (which are designated by reference numeral 579a). USER 3 accepts the offer and the collaborative messaging environment 500 adds USER 3 to the chat session 573, as designated by step 587. The third chat client 579 renders past chat messages (which are designed by reference numeral 579b) which may be forwarded by the communications engine 502. The communications engine 502 also sends messages 575d, 577b to respective first and second chat clients 575, 577 indicating that USER 3 has joined the chat. USER 3 asks to be updated about the patient's condition 579c.

Referring now to FIG. 5B, in which like elements with FIG. 5A are designated by like reference numerals, another illustrative collaborative message environment 500 for sending and receiving messages among users 511 includes a communications engine 502 for automatically generating user contacts 505 and offering to add the user contacts 505 to user contact lists 508. An exemplary mechanism of the collaborative messaging environment 500 for carrying out these operations is designated by steps 591-595. In this example, users 511 accept and/or reject the offers to add user contacts 505. In some instances, there may be non-mutual agreement among the users 511 to accept and/or reject the offers. For example, a first user may accept a request to add a second user to the first user's contact list, while the second user may reject a request to add the first user to the second user's contact list.

The communications engine 502 automatically generates user contacts 505 (step 591) by comparing user filters and generating user contacts (respective steps 592 and 593) in response to the comparison. For example, the communications engine 502 may compare user filters 506 at predetermined time intervals in order to process any updates to the user filters 506. For example, a user filter may have been added, removed, and/or have modified attribute information during a particular time interval. The communications engine 502 automatically generates the updates at the expiration of the time interval. Alternatively, the communications engine 502 may compare user filters 506 and generates user contacts 508 in response to an event, such as the updating of attribute information from an information source. For example, the communications engine 502 may accept contextual and/or communications information from one or more external sources and regenerate user contacts 505 based on a comparison of such information in one or more user filters 506. The contextual information may be from a radar system for tracking aircraft and the communications information may be one or more queued text messages from a text-messaging server.

For example, a first passenger in a first military aircraft may be discussing local weather advisories with a ground station, as indicated by the first passenger's communications attributes stored in the first passenger's user filter, which include keywords such as “lightning strike events” and/or “turbulence at altitude X.” A second military aircraft may be approaching the vicinity of the first military aircraft, as revealed in a comparison between the geographic coordinates stored in the respective contextual attributes of the first and second passenger filters. Based on the proximity match in the user filters 106, the contact generator 104 generates a new user contact for the second passenger to add to the first passenger's user contact list. Similarly, the contact generator 104 may generate a new user contact for the first passenger to add to the second passenger's user contact list. Such dynamic generation of user contacts 105 and updating of user contact lists 108 enables the passengers to learn about and contact each other to discuss weather advisories and other learned information.

The communications engine 502 sends offers to one or more users 511, for example, a first user 511a, a second user 511b, and a third user 511c, respectively referred to hereinafter as USER 1, USER 2, and USER 3, to accept or reject generated user contacts 505. For example, the communications engine 502 sends an offer to USER 1 on a first client device 596 to add USER 3 to USER 1's contact list (step 594a). The first client device 596 notifies USER 1 and prompts USER 1 596a to accept or reject the offer to add USER 3. USER 1 accepts the offer 596b and the first client device 596 generates a request to add USER 3 to USER 1's user contact list. The communications engine 502 responds to the request by adding USER 3 to USER 1's contact list (step 595).

As can be seen on FIG. 5B, the generated contacts 505 and offers to add user contacts may not be mutual. For example, in one exemplary application incorporating the inventive concepts, USER 3 is a supervisor user who manages an incident, such as a traffic accident, USER 1 is a first responder at the scene the traffic accident, and USER 2 is a staff coordinator at a hospital to treat the traffic accident victims. Here, the communications engine 502 offers to add USER 1 and USER 2 to USER 3's contact list, so that USER 3 may communicate with and coordinate efforts between USER 1 and USER 2. However, the communications engine 502 does not generate mutual contacts between USER 1 and USER 2, instead relying on USER 3 to coordinate the communications. This saves the communications engine 502 from having to send and receive redundant messages among USER 1 and USER 2, which can reduce overhead and load on the network.

Referring again to FIG. 5B, the communications engine 502 sends an offer to USER 2 (step 594b) on a second client device 597 to add USER 3 to USER 2's contact list, and sends two offers to USER 3 (step 594c) on a third client device 599 to add USER 1 and USER 2 to USER 3's contact list. Here, unlike USER 1, USER 2 rejects the offer 597a to add USER 3 to USER 2's contact list, perhaps because USER 2 is only interested in communicating with hospital personnel. However, USER 3 accepts both offers 599a, 599b, since USER 3 needs to coordinate USER 1's and USER 2's efforts to mitigate the consequence of the traffic accident.

With such an arrangement, users may control contacts and communicate with whomever they desire. Users dynamically discover contacts and may accept or reject offers to add the contacts to their contact lists. This minimizes unwanted messages, while allowing users to learn about and maintain contacts that are important to a particular task-at-hand. Users may eliminate contacts when they are no longer needed or when they are no longer available.

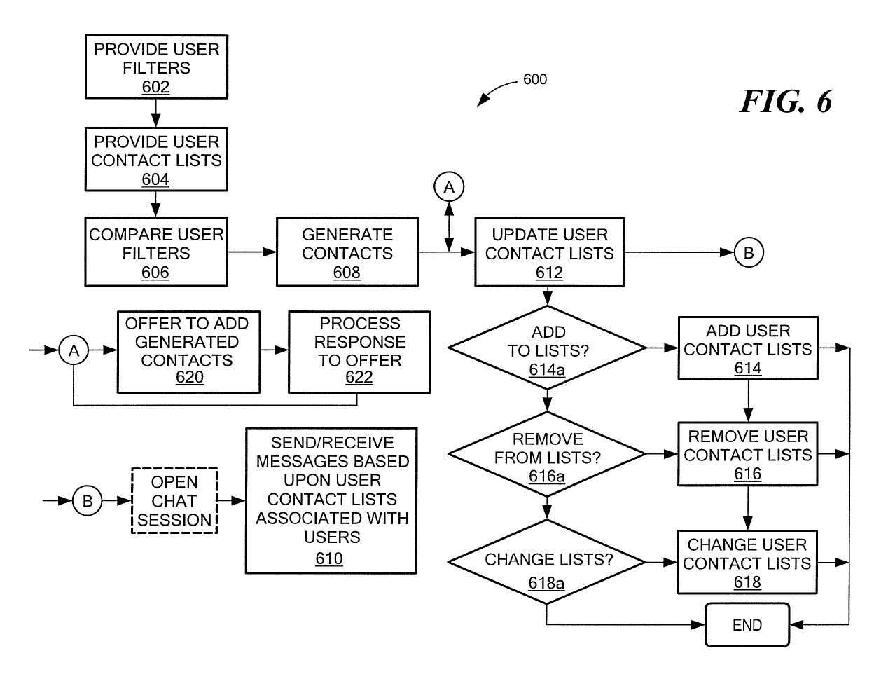

Referring now to FIG. 6, a collaborative messaging method 600 includes, in a communications engine, providing user filters associated with users 602, providing user contact lists associated with the users 604, comparing the user filters 606, and generating user contacts including updating the user contact lists 608. In a further embodiment, the method 600 includes sending and receiving messages over a chat session among users based upon the user contact lists associated with the users 610.

In another embodiment, the method 600 includes updating the user contact lists 612 by adding user contacts to the lists 614, removing user contacts from the list 616, or changing user contact information in the lists 618. Such updating includes determining whether updates are to add contacts to lists 614a, remove contacts from lists 616a, or change contact information in lists 618a.

In a further embodiment, the method 600 includes sending an offer to add generated user contacts to user contact lists 620, and processing a response to the offer 622. The response may include an acceptance by a user to add an offered user contact. In such an instance, processing the response to the offer 622 may include adding the generated user contacts to user contact lists.

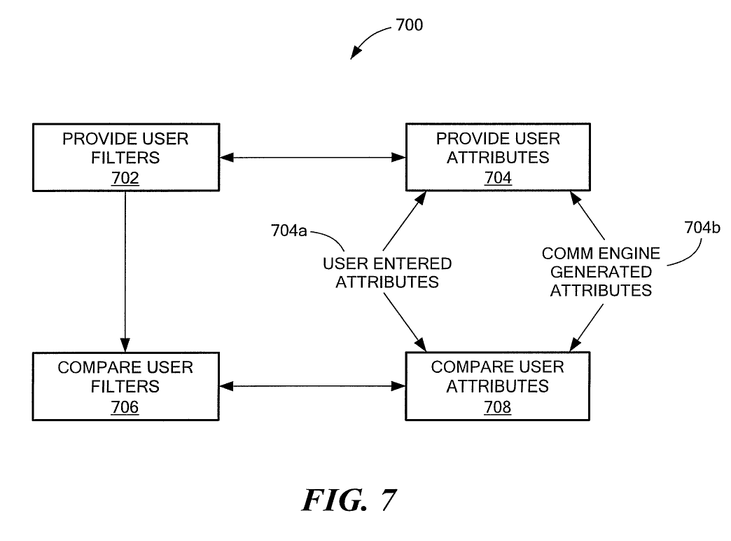

Referring now to FIG. 7, in a further embodiment 700 of the method of FIG. 6, providing user filters 702 includes providing user attributes 704. At least a first portion of the user attributes 704a are entered by users, and at least a second portion of the user attributes 704b are generated by a communications engine, as may be similar to the communications engine 102 described in conjunction with FIG. 1. Still further, comparing user filters 706 includes comparing user attributes 708 including the user entered attributes 704a and the communications engine generated attributes 704b.

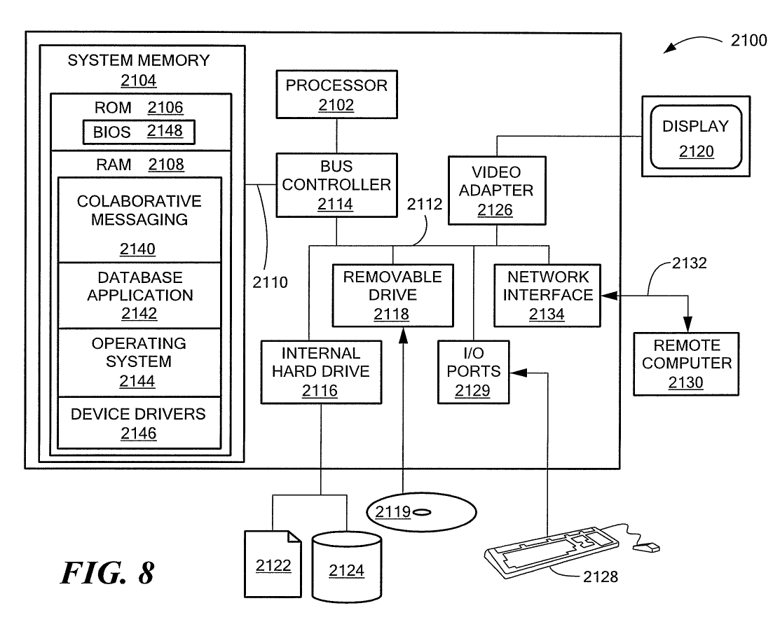

FIG. 8 illustrates a computer 2100 suitable for supporting the operation of an embodiment of the collaborative messaging systems, concepts, and techniques described herein. The computer 2100 includes a processor 2102, for example, a dual-core processor, such as the AMD Athlon™ X2 Dual Core processor from the Advanced Micro Devices, Inc. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network. Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing the collaborative messaging systems and methods described herein. In a further embodiment, the computer 2100 may execute various components of a communications engine as may be similar to that described in conjunction with FIG. 1. In still a further embodiment, the communications engine implements the components on different processors, for example, a first processor and a second processor. For example, the first processor implements a contact generator and the second processor implements a filter processor (see FIG. 1). Advantageously, the division of processing function saves time and overhead and allows for asynchronous programming. For example, the filter processor may execute comparisons between user filters while the contact generator sends offers to users to add user contacts and awaits responses from users.

Furthermore, collaborative messaging system data may be saved in internal hard drive storage 2116, read-in from removable drive 2118, or received via the network 2132 from remote computer 2130, and loaded into RAM 2108. For example, user filters and user contact lists, as may be similar to user filters 106 and user contact lists 108 described in conjunction with FIG. 1, may be loaded into RAM 2108. The data may be stored in a database format to execute in a database application or in a file format, which can include, but is not limited to, a comma-delimited text file.

In a further embodiment, the first and second processors may be respective processors of a dual-core processor. Alternatively, the first and second processor may respective first and second computing devices. Output of the first and/or second processors may be rendered on display 2120.

The computer 2100 may execute a database application 2142, such as Oracle™ database from Oracle Corporation, to model, organize, and query data stored in database 2124. The data may be used by the computer-readable modules and applications 2140 and/or passed over the network 2132 to the remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A collaborative messaging system, comprising:
a communications engine for sending and receiving messages among a plurality of users, comprising:
a contact generator to generate at least one user contact;
a plurality of user filters, each associated with at least one of the plurality of users; and
a plurality of user contact lists, each associated with at least one of the plurality of users and adapted to contain at least one user contact,
wherein, in response to a comparison between user filters, the contact generator is configured to update at least one of the plurality of user contact lists.

2. The system of claim 1, wherein the communications engine sends and receives messages over a chat session between ones of the plurality of users based upon the user contact lists associated with the users.

3. The system of claim 1, wherein each of the plurality of user filters comprises at least one personal user attribute.

4. The system of claim 1, wherein each of the plurality of user filters comprises at least one communications attribute related to at least one of the messages.

5. The system of claim 1, wherein each of the plurality of user filters comprises at least one contextual attribute related to a context of the associated at least one user.

6. The system of claim 1, wherein each of the plurality of user filters comprises a plurality of user attributes and the communications engine generates a first portion of the plurality of the user attributes.

7. The system of claim 6, wherein the communications engine generates a second portion of the plurality of user attributes in response to a request to enter the second portion of the plurality of user attributes.

8. The system of claim 1, further comprising:
a filter processor for comparing user filters in response to a request from at least one of the plurality of users,
wherein the request is related to a user filter associated with the requesting user.

9. The system of claim 1, wherein the communications engine is further configured to send a message to one of the plurality of users associated with an updated user contact list.

10. The system of claim 1, wherein in response to the comparison between user filters, the contact generator is configured to update at least one of the plurality of user contact lists by adding or removing a user contact from one of the user contact lists.

11. The system of claim 1, wherein in response to the comparison between user filters, the contact generator is configured to update at least one of the plurality of user contact lists by changing information associated with a user contact contained on a user contact list.

12. The system of claim 1, wherein the communications engine is further configured to send an offer to add the at least one generated contact, and the contact generator is further configured to add the at least one generated user contact to at least one of the plurality of user contact lists in response to a request to add the at least one generated user contact.

13. A collaborative messaging method, comprising:
in a communications engine, providing a plurality of user filters, each associated with at least one of a plurality of users, and a plurality of user contact lists, each associated with at least one of the plurality of users and adapted to contain at least one user contact;
performing a comparison between user filters; and
generating the at least one user contact and updating at least one of the user contact lists.

14. The method of claim 13, further comprising:
sending and receiving messages over a chat session among ones of the plurality of users based upon the user contact lists associated with the users.

15. The method of claim 13, wherein each of the plurality of user filters comprises at least one personal user attribute.

16. The method of claim 13, wherein each of the plurality of user filters comprises at least one communications attribute related to at least one communications message.

17. The method of claim 13, wherein each of the plurality of user filters comprises at least one contextual attribute related to a context of the associated ones of the users.

18. The method of claim 13, wherein each of the plurality of user filters comprises a plurality of user attributes and further comprising:
generating a first portion of the plurality of the user attributes.

19. The method of claim 18, further comprising:
generating a second portion of the plurality of user attributes in response to a request to enter the second portion of the plurality of user attributes.

20. The method of claim 13, wherein performing a comparison between user filters comprises:
comparing user filters in response to a request from at least one of the plurality of users,
wherein the request is related to a user filter associated with the at least one requesting user.

21. The method of claim 13, further comprising:
sending a message to one of the plurality of users associated with an updated user contact list.

22. The method of claim 13, wherein performing a comparison between user filters comprises:
updating at least one of the plurality of user contact lists by adding or removing a user contact from one of the user contact lists.

23. The method of claim 13, wherein performing a comparison between user filters comprises:
updating at least one of the plurality of user contact lists by changing information associated with a user contact contained on a user contact list.

24. The method of claim 13, further comprising:
sending an offer to add the at least one generated contact; and
adding the at least one generated user contact to at least one of the plurality of user contact lists in response to a request to add the at least one generated user contact.
